(19) United States
(12) Patent Application Publication
(10) Pub. No.: US 2016/0330815 A1
(43) Pub. Date: Nov. 10, 2016

(54) ILLUMINATION METHOD, AND ILLUMINATION DEVICE

(71) Applicant: NATIONAL INSTITUTE OF ADVANCED INDUSTRIAL SCIENCE AND TECHNOLOGY, Tokyo (JP)

(72) Inventors: Seiji NAKAGAWA, Ikeda-shi (JP); Yosuke OKAMOTO, Ikeda-shi (JP)

(21) Appl. No.: 15/111,707

(22) PCT Filed: Sep. 2, 2014
(86) PCT No.: PCT/JP2014/072983

§ 371 Date: Jul. 14, 2016

(30) Foreign Application Priority Data
Jan. 16, 2014 (JP) 2014-006128

(51) Int. Cl. H05B 33/08; A47B 96/00; F21V 19/02; F21V 23/00; F21V 23/02

(52) U.S. Cl. CPC H05B 33/0845; F21V 23/003; F21V 23/02; F21V 19/02; H05B 33/0809; A47B 96/00; F21Y 2115/10

(57) ABSTRACT

An illuminating method for illuminating a specific region S and peripheral regions Ca, Cb thereof by a plurality of light sources 10a, 10b, wherein the light sources 10a, 10b have mutually different flicker frequencies, and their irradiation areas Ia, Ib overlap each other in the specific region S, thus causing an observer to perceive in the specific region S a flicker stimulation having a frequency different from the flicker frequencies of light perceived by the observer in the peripheral regions Ca, Cb where the irradiation areas do not overlap each other.

### TECHNICAL FIELD

The present invention relates to an illumination method and an illumination device.

### BACKGROUND ART

Flickering light with time-variant brightness at such a relatively low frequency (about 60 Hz or less) that an observer can perceive flicker is noticeable and attracts the observer's attention, and, to date, has been used for illumination devices. Known examples include, in addition to guide lights for indicating emergency exits and warning lights for indicating the presence of emergency vehicles or dangerous places, security devices for deterring stalkers and warning people in the vicinity about the stalkers (Patent Literature 1), display devices (Patent Literature 2) and vending machines (Patent Literature 3) for drawing attention to products, and illumination devices for enhancing the mood of a space (Patent Literatures 4 to 6).

When flickering light has a high flicker frequency, an observer does not perceive flicker and is unable to distinguish between flickering light and non-flickering light that shines constantly. A known example involving high-frequency flickering light is a transmission device that performs signal transduction by superimposing high-frequency flicker signals onto illumination light (Patent Literature 7).

### CITATION LIST

### Patent Literature

Patent Literature 1: JP 2010-33812A

Patent Literature 2: JP 2000-331228A

Patent Literature 3: JP 2012-190140A

Patent Literature 4: JP 2007-194117A

Patent Literature 5: JP 2010-15962A

Patent Literature 6: JP 2000-113702A

Patent Literature 7: JP 2005-142773A

### SUMMARY OF INVENTION

### Technical Problem

In the case of illuminating objects such as products by taking advantage of flickering light only, it is possible to noticeably illuminate objects that are present in a specific region, but it is not possible to illuminate other objects that are present in peripheral regions thereof. Therefore, such a manner of illumination is problematic by being unsuitable for applications where only some objects are to be made particularly noticeable while illuminating a large number of objects.

On the other hand, illuminating objects present in a specific region solely by flickering light while illuminating other objects present in peripheral regions thereof by non-flickering light that shines constantly requires a flickering-light source or a non-flickering-light source for each object, and is thus likely to be problematic with respect to cost and installation space. Moreover, in the case where illuminated objects move, the regions irradiated with flickering light and non-flickering light need to be shifted according to the movement of the objects, which is likely to result in a complex mechanism and control therefor.

Furthermore, in the case of illuminating all objects by non-flickering light while illuminating objects that are present in a specific region also by flickering light, an observer is likely to be dazzled by glare and feel uncomfortable because the brightness range of the flickering light with a varying brightness is higher than the non-flickering light. Moreover, reducing the brightness of non-flickering light to suppress such a phenomenon is problematic by making it difficult to see the objects in peripheral regions.

Accordingly, an object of the present invention is to provide an illumination method and an illumination device capable of noticeably illuminating a specific region while also sufficiently illuminating peripheral regions thereof.

### Solution Problem

The foregoing object of the present invention is achieved by an illumination method for illuminating a specific region and peripheral regions thereof by a plurality of light sources, wherein the light sources have mutually different flicker frequencies, and irradiation areas of the light sources partially overlap each other in the specific region, thus causing an observer to perceive in the specific region a flicker stimulation having a frequency different from the flicker frequencies of light perceived by the observer in the peripheral regions where the irradiation areas do not overlap each other.

For this illumination method, it is preferable that the flicker frequencies of the light sources are all set in a 10 to 30 Hz range.

Moreover, by moving the irradiation areas of the light sources, the range of the specific region can be changed.

Also, the foregoing object of the present invention is achieved by an illumination device comprising a plurality of light sources for illuminating a specific region and peripheral regions thereof, wherein the light sources have mutually different flicker frequencies, and irradiation areas of the light sources partially overlap each other in the specific region, thus causing an observer to perceive in the specific region a flicker stimulation having a frequency different from the flicker frequencies of light perceived by the observer in the peripheral regions where the irradiation areas do not overlap each other.

### Advantageous Effects of Invention

The present invention can provide an illumination method and an illumination device capable of noticeably illuminating a specific region and also sufficiently illuminating peripheral regions thereof.

### BRIEF DESCRIPTION OF DRAWINGS

FIG. 1 is a schematic configurational diagram of an illumination device according to one embodiment of the present invention.

FIGS. 2(a) and 2(b) show temporal waveforms of luminance change of flickering lights having different flicker frequencies, and FIG. 2(c) is a temporal waveform of luminance change of a light obtained by combining these flickering lights.

FIG. 3 shows temporal waveforms of flickering lights whose luminances change at different degrees of modulation (M1, M2).

FIG. 4 shows thresholds of detecting flickers at modulated frequencies of amplitude-modulated flickering lights.

FIG. 5 is a schematic configurational diagram of an illumination device according to another embodiment of the present invention.

FIG. 6 is a schematic configurational diagram of an illumination device according to yet another embodiment of the present invention.

FIG. 7 is a schematic configurational diagram of an illumination device according to yet another embodiment of the present invention.

FIG. 8 is a schematic configurational diagram of an illumination device according to yet another embodiment of the present invention.

### DESCRIPTION OF EMBODIMENTS

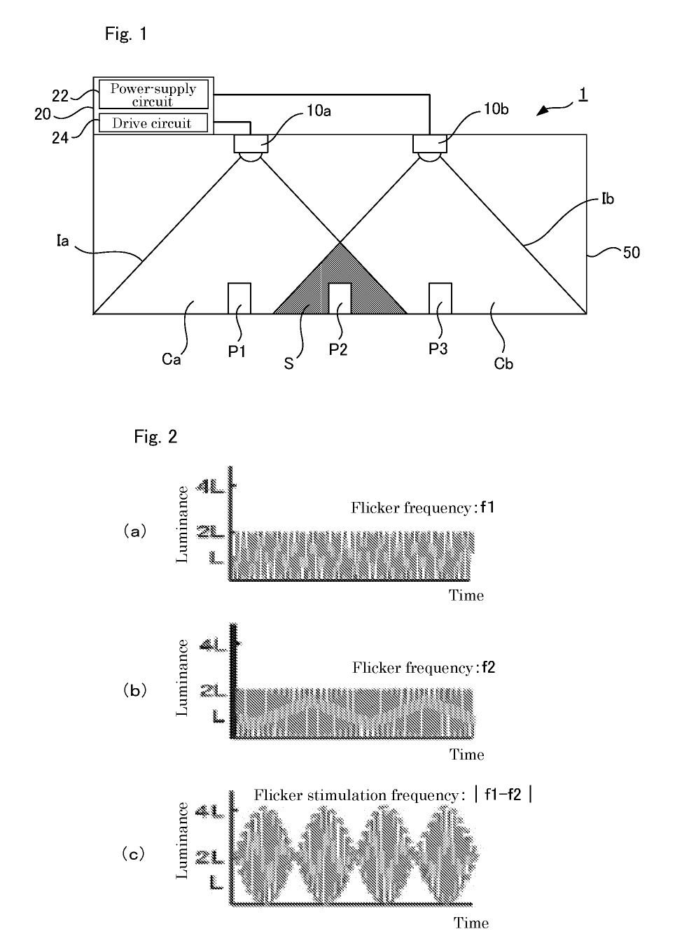

Below, an embodiment of the present invention will now be described with reference to the attached drawings. FIG. 1 is a schematic configurational diagram of an illumination device according to one embodiment of the present invention. An illumination device 1 shown in FIG. 1 comprises a plurality of light sources 10a, 10b attached to the upper part of a showcase 50 for illuminating a plurality of products P1, P2, and P3 (such as jewelry, food, or clothing) placed inside the showcase 50, and a controller 20 for controlling the luminances of the light sources 10a, 10b.

The light sources 10a, 10b are each composed of a single or a plurality of light emitting elements (for example, an LED chip) or the like, and are placed such that respective irradiation areas Ia, Ib thereof partially overlap each other in a specific region S that is a spatial domain inside the showcase 50. Accordingly, the product P2 in the specific region S is illuminated by both light sources 10a, 10b, while the products P1, P3 in peripheral regions Ca, Cb that are in the irradiation areas Ia, Ib and that do not overlap each other are illuminated by the light sources 10a, 10b, respectively. Light emitted from the light sources 10a, 10b contains a wavelength component that is in a visible light region (about 380 to 750 nm). There may be one or more such wavelength components, or such a wavelength component may have a continuous spectrum.

The controller 20 comprises a power-supply circuit 22 and a drive circuit 24, and is connected to a commercial power supply (not shown). The power-supply circuit 22 comprises a rectification circuit, a switching element, a transformer, and so on, and rectifies commercially supplied power into direct-current power. The drive circuit 24 produces pulse signals corresponding to the flicker frequency data of the light sources 10a, 10b stored in a memory in advance. The flicker frequencies of the light sources 10a, 10b are independently set, and the controller 20 causes the light sources 10a, 10b to flicker at mutually different frequencies according to signals from the drive circuit 24. Although the waveform of pulse signals is sinusoidal in this embodiment, the waveform may be rectangular, triangular, or the like.

FIG. 2(a) and FIG. 2(b) show examples of luminance changes of the light sources 10a, 10b, respectively. The flickering lights of the light sources 10a, 10b have the same phase, and their average luminance values and amplitude values are the same (=L). One light source 10a flickers at a flicker frequency f1, and the other light source 10b flickers at a flicker frequency f2. FIG. 2(c) shows an example of luminance change in the overlapping region where the irradiation areas of the light sources 10a, 10b overlap. When the difference |f1-f2| between the absolute values of the flicker frequencies f1, f2 is small, the flicker stimulation resulting from the difference |f1-f2|, which is composed of the envelope of the waveform of frequency (f1+f2/2, is produced due to the superposition of the waveforms shown in FIGS. 2(a) and 2(b) in the overlapping region of the irradiation areas. For example, the flicker frequencies f1, f2 of the light sources 10a, 10b having frequencies of 20 Hz and 22 Hz, respectively, can express a flicker stimulation of 2 Hz. The average luminance and the amplitude of the flicker stimulation are both 2 L, i.e., two times greater than the average luminances and the amplitudes of the light source 10a, 10b, and it is thus possible to make the specific region S sufficiently more noticeable than the peripheral regions Ca, Cb.

According to the illumination device 1 of this embodiment, not only can the light sources 10a, 10b having mutually different flicker frequencies f1, f2 illuminate the peripheral regions Ca, Cb, respectively, but also they can cause an observer to perceive the flicker stimulation having a frequency of |f1-f2|, which is the difference frequency of the flicker frequencies f1, f2, in the specific regions S. It is thus possible to make the product P2 placed in the specific region S noticeable while sufficiently illuminating the products P1, P3 placed in the peripheral regions Ca, Cb, respectively. Accordingly, a separate light source is unnecessary for illuminating the specific region S, and it is thus possible to reduce cost and space.

When the size of the specific region S needs to be changed according to, for example, the change of the shape/size of the product P2, such a change can be easily dealt with merely by adjusting the overlapping region of the irradiation areas Ia, Ib of the light sources 10a, 10b.

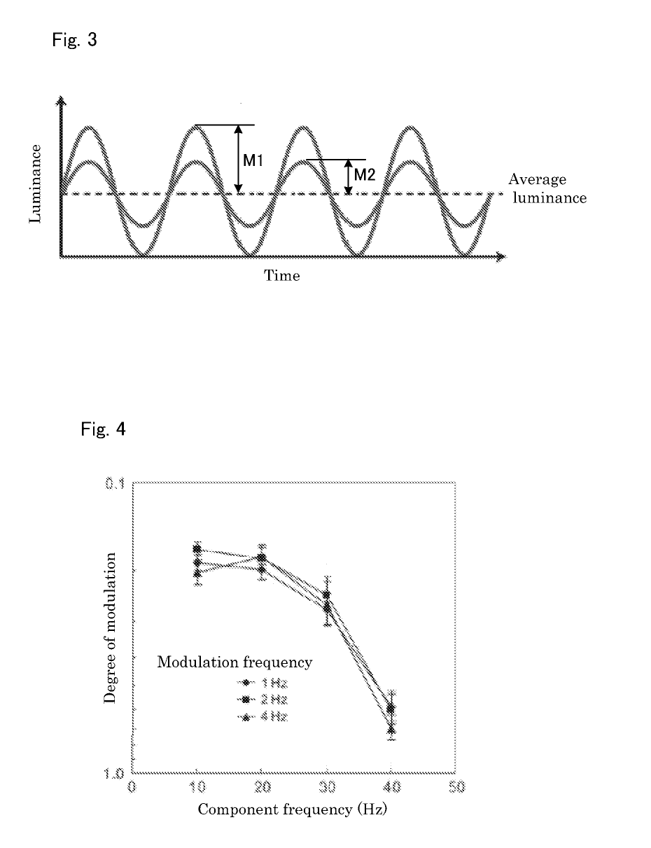

The greater the average luminances and degrees of modulation of the flickering lights of the light sources 10a, 10b are, the greater the temporal changes of luminances in the peripheral regions Ca, Cb and in the overlapping region S can be, thus making it easier for an observer to perceive flicker. As shown in FIG. 3, when the degree of modulation of the luminance change of flickering light has a value close to 1 (M1), flicker is intensely perceived, and, for example, even when flickering light has a degree of modulation smaller than 1 (M2), it is possible to cause an observer to intensely perceive luminance changes by increasing the average luminance, and such luminance changes are combined especially in the overlapping region S and are thus more easily perceived. That is to say, the degree of modulation of flickering light can be suitably set to be within the range of 0 to 1.

According to the research conducted by the inventors, concerning light (amplitude-modulated flickering light) obtained by amplitude-modulating the flicker at a certain temporal frequency (a component frequency) with another temporal frequency (a modulation frequency), flicker at the component frequency as well as flicker at the modulation frequency may be perceived, but flicker at the modulation frequency is unlikely to be perceived when the component frequency is high. In the case where the component frequency is so high that flicker is not perceived, flicker at the modulation frequency is not perceived. Accordingly, it is necessary to set the flicker frequencies f1, f2 of the light sources 10a, 10b to be not greater than the critical flicker frequency (CFF, about 60 Hz), which is the frequency limit below which an observer can perceive flicker.

FIG. 4 shows the relationship between the component frequency of flickering light and the threshold value of the degree of modulation at which flicker is perceivable, with a modulation frequency being a parameter. It can be understood from the results shown in FIG. 4 that, irrespective of the modulation frequency, the higher the component frequency is, the higher the threshold value of the degree of modulation is, and it is thus difficult to perceive flicker. In view of this knowledge, the inventors accomplished the present invention based on the finding that perceptional characteristics similar to the above are also obtained with respect to a flicker stimulation at a difference frequency obtained by combining two flickering lights that have different flicker frequencies.

That is to say, it is preferable to set the flicker frequencies f1, f2 of the light sources 10a, 10b to be not greater than the aforementioned critical flicker frequency to cause an observer to easily perceive a flicker stimulation in the specific region S. Moreover, according to the results shown in FIG. 4, a high component frequency does not result in an excessively lowered sensitivity of perceiving amplitude-modulated flickering light as long as the component frequency is within the range of 10 to 30 Hz, but on the other hand, the sensitivity of perceiving amplitude-modulated flickering light is drastically lowered when the component frequency exceeds 30 Hz and, therefore, setting the flicker frequencies f1, f2 of the light sources 10a, 10b to be 10 to 30 Hz allows an observer to easily perceive the flicker stimulation of the difference frequency |f1-f2| produced in the specific region S.

Even when the flicker frequencies f1, f2 of the light sources 10a, 10b are lower than the critical flicker frequency, it is more difficult for an observer to perceive flicker if the flicker frequencies are closer to the critical fusion frequency. Thus, when it is desired to make it difficult for an observer to perceive flicker in the peripheral regions Ca, Cb (i.e., to cause an observer to perceive as if illumination is by non-flickering light) and, on the other hand, it is desired to cause the observer to perceive a flicker stimulation in the specific region S, the flicker frequencies f1, f2 are preferably set to be 20 to 30 Hz. Moreover, when it is desired to cause the observer to perceive flicker not only in the specific region S but also in the peripheral regions Ca, Cb, the flicker frequencies f1, f2 are set to be around 10 Hz.

Although the frequency |f1-f2| of the flicker stimulation perceived in the specific region S is set at such a frequency that an observer perceives the intended flicker, the frequency |f1-f2| is preferably lower than the flicker frequencies f1, f2 of the light sources 10a, 10b, and is preferably, for example, 1 to 10 Hz so that the observer can clearly perceive flicker. According to the results shown in FIG. 4, flicker can be successfully perceived when the difference frequency |f1-f2| is at least within the range of 1 to 4 Hz. Configuring the difference frequency |f1-f2| to be different from the flicker frequencies f1, f2 makes it possible to produce in the specific region S a flicker stimulation that is different from the flickers perceived in the peripheral regions Ca, Cb.

One embodiment of the present invention has been described in detail above, but the specific aspects of the present invention are not limited to the above embodiment. For example, although the above embodiment has been described in reference to an example in which the irradiation areas Ia, Ib of two light sources 10a, 10b overlap each other, there may be three or more light sources, and the same effect as the above embodiment can be provided by placing the light sources such that there is at least one overlapping region where their irradiation areas overlap. The luminances, degrees of modulation, wavelengths, phases, and time-variant patterns of flickering lights may be the same or different among the plurality of light sources.

Moreover, it is desirable to adjust the intensity of flickering light perceived in the overlapping region according to the point of use or the purpose of use by suitably controlling the luminance and the degree of modulation of each light source.

Moreover, although the luminance, degree of modulation, wavelength, phase, and time-variant pattern of flickering light of each light source are constant over time in the above embodiment, they may be varied in a continuous or non-continuous manner as the time passes. In this way, how flickering light appears in the peripheral regions and in the specific region changes over time, and it is possible to create a theatrical atmosphere.

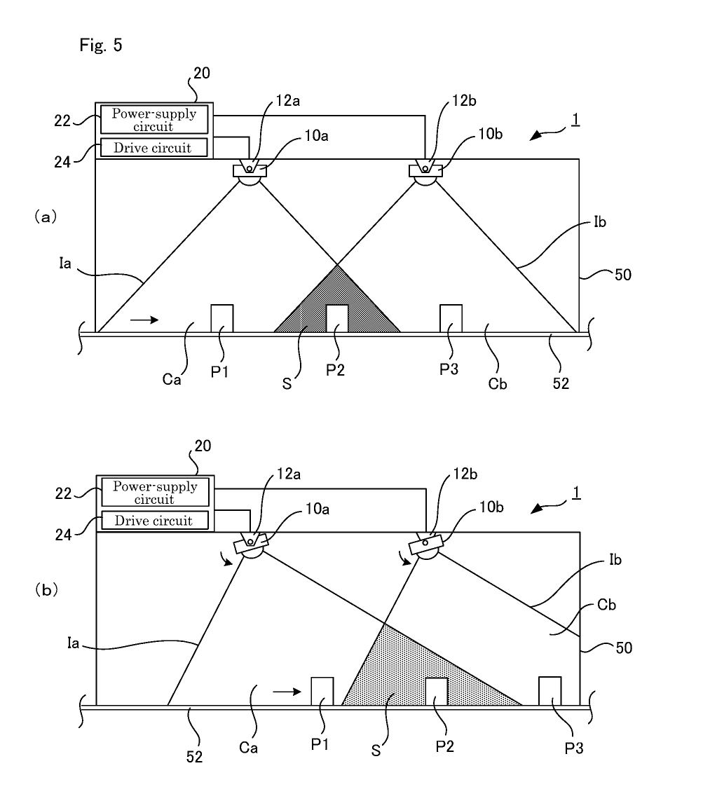

Moreover, as shown in FIG. 5(a), the irradiation areas of the light sources 10a, 10b may be made movable, for example, by attaching the light sources 10a, 10b so as to be rotatable in the vertical direction to brackets 12a, 12b, respectively, that are fixed to the ceiling surface of the showcase 50. According to this configuration, when the products P1 to P3 inside the showcase 50 are moved, for example, by being conveyed by a conveyor 52, the control device 20 controls the irradiation areas of the light sources 10a, 10b such that the light sources 10a, 10b are rotated by a motor (not shown) according to the movement of the products P1 to P3 as shown in FIG. 5(b), and it is thus possible to maintain the products P1 to P3 in the peripheral regions Ca, Cb and the specific region S. In this way, in the case where the extent (such as position and size) of the specific region S needs to be changed over time as well, the lighting device 1 shown in FIG. 5 can be easily controlled because a light source that solely illuminates the specific region S is not necessary. The irradiation areas of the light sources 10a, 10b can be moved not necessarily only by rotating the light sources 10a, 10b but also, for example, by moving the light sources 10a, 10b themselves. Moreover, it is also possible to move the irradiation area of one light source 10a while securing the irradiation area of the other light source 10b. In this way, overlapping of irradiation areas are created intermittently, and it is thus possible to provide strong mood-enhancing effects.

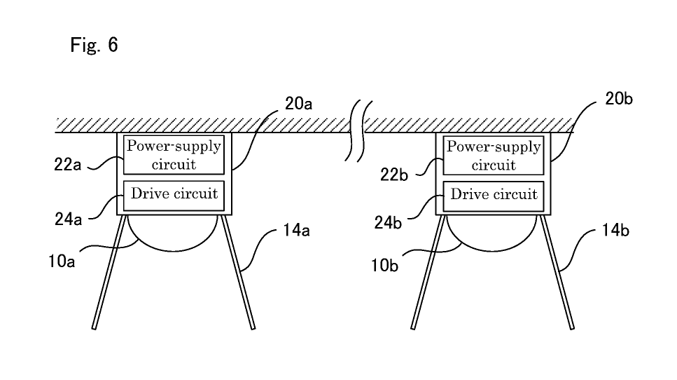

As shown in FIG. 6, controllers 20a, 20b may be provided for the light sources 10a, 10b in one-to-one correspondence so that the controllers 20a, 20b are each connected to a commercial power source or the like to receive a supply of electric power. The controllers 20a, 20b respectively comprise power supply circuits 22a, 22b and drive circuits 24a, 24b, and it is thus possible to individually set the flicker frequencies of the light sources 10a, 10b.

Also, as shown in FIG. 6, shielding members 14a, 14b such as lampshades may be provided to surround the light sources 10a, 10b, respectively, and the desired irradiation areas of the light sources 10a, 10b can be easily obtained by suitably adjusting the size and the shape of the lower openings of the shielding members 14a, 14b. For increased luminance, it is preferable to provide the shielding members 14a, 14b with a mirror-like, white, or similar inner surface to increase reflectivity, but in the case of suppressing to some extent the luminance of the irradiation areas, the shielding members 14a, 14b may be provided with a black inner surface or the like.

Although the light sources 10a, 10b are placed above the specific region and the peripheral regions in the above-described embodiments, the locations of the light sources 10a, 10b are not particularly limited. For example, the light sources 10a, 10b may be placed next to, below, in front of, or behind the specific region and the peripheral regions. Alternatively, one light source 10a may be placed above, and the other light source 10b may be placed below. Even when there is an object other than the target of irradiation around the specific region and the peripheral regions, it is possible to illuminate the specific region and the peripheral regions through this object as long as this object transmits light.

Although the above embodiment has been described in reference to an example in which the illumination device of the present invention is used for illuminating products placed inside a showcase, the illumination device of the present invention is also suitable for illuminating, for example, samples for vending machines, indoor and outdoor exhibits (such as paintings, ornaments, plants, and signboards), display panels, actors on a stage, and so on, and its applications are not particularly limited. In particular, the illumination device of the present invention can be suitably used in applications where one or more objects are entirely illuminated and, at the same time, only a part of such object(s) is illuminated to be particularly noticeable.

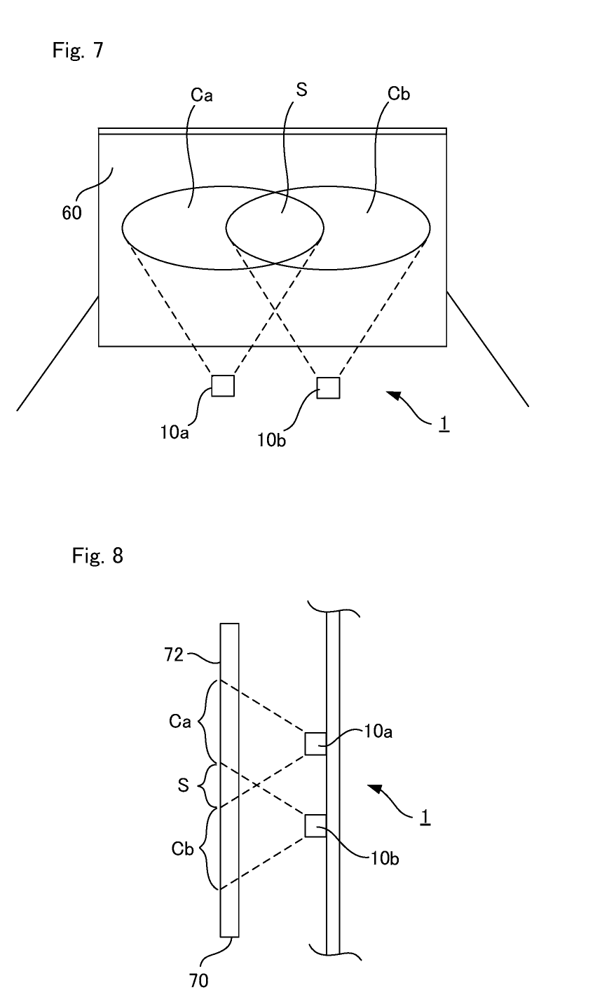

For example, as shown in FIG. 7, when a display 60, such as a signboard, a panel, a screen, or an outer wall of a building, is provided in an upright state, the light sources 10a, 10b are placed in front of the display 60 so that the specific region S and the peripheral regions Ca, Cb on the surface of the display 60 can be illuminated. This illumination method makes it possible to draw observers' attention to specific information or the like appearing on the display 60.

Moreover, as shown in FIG. 8, for home-use TV sets, large-size monitors, personal digital assistants, billboards, or the like, the light sources 10a, 10b are placed behind a display panel 70 such as a light-transmitting liquid crystal panel or other light-transmitting panels to allow light emitted from the light sources 10a, 10b to penetrate the display panel 70 and illuminate the specific region S and the peripheral regions Ca, Cb in a display part 72 of the display panel 70.

### REFERENCE SIGNS LIST

1 Illumination device
10a, 10b Light sources
Ia, Ib Irradiation areas
S Specific region
Ca, Cb Peripheral regions
f1, f2 Flicker frequencies

1. An illuminating method for illuminating a specific region and peripheral regions thereof by a plurality of light sources, wherein
the light sources have mutually different flicker frequencies, and
irradiation areas of the light sources partially overlap each other in the specific region, thus causing an observer to perceive in the specific region a flicker stimulation having a frequency different from the flicker frequencies of light perceived by the observer in the peripheral regions where the irradiation areas do not overlap each other.

2. The illuminating method according to claim 1, wherein the flicker frequencies of the light sources are all set in a 10 to 30 Hz range.

3. The illuminating method according to claim 1, wherein the irradiation areas of the light sources are moved to change the range of the specific region.

4. An illuminating device comprising a plurality of light sources for illuminating a specific region and peripheral regions thereof, wherein
the light sources have mutually different flicker frequencies, and
irradiation areas of the light sources partially overlap each other in the specific region, thus causing an observer to perceive in the specific region a flicker stimulation having a frequency different from the flicker frequencies of light perceived by the observer in the peripheral regions where the irradiation areas do not overlap each other.

5. The illuminating method according to claim 2, wherein the irradiation areas of the light sources are moved to change the range of the specific region.
